(19) United States
(12) Patent Application Publication
(10) Pub. No.: US 2005/0046757 A1
(43) Pub. Date: Mar. 3, 2005

(54) Image signal processor circuit and portable terminal device

(76) Inventors: Tomoaki Okabe, Ota-shi (JP); Hideyuki Fujii, Ota-shi (JP)

Correspondence Address: Jonathan P. Osha;Osha & May L.L.P., Suite 2800, 1221 McKinney St., Houston, TX, 77010, US

(21) Appl. No.: 10/925,802

(22) Filed: Aug. 25, 2004

(30) Foreign Application Priority Data
Aug. 27, 2003 (JP) 2003-303528

(51) Int. Cl. H04N 5/64

(52) U.S. Cl. 348/838; 348/790

(57) ABSTRACT

A portable device which can display a television image. A first RAM is provided on an LSI processor chip of a portable phone. A processor in the LSI processor chip writes data of an odd field to the first RAM during an odd field period and reads the data from the first RAM and outputs to an LCD controller during the next even field period. A processor in the LCD controller writes data to a third RAM during the even field period and again reads the data from the third RAM and displays on an LCD panel during the next odd field period.

### CROSS-REFERENCE TO RELATED APPLICATIONS

The priority Japanese Patent Application Number 2003-303528 upon which this patent application is based is hereby incorporated by reference.

### BACKGROUND OF THE INVENTION

1. Field of the Invention

The present invention relates to an image signal processor circuit and a portable terminal device and, in particular, to a technique for receiving an input television image signal and outputting the input television image signal to a display for a portable terminal.

2. Description of the Related Art

Conventionally, techniques are known to provide a television tuner for receiving a television image signal using a portable terminal device such as a portable phone and a PDA (Personal Digital Assistant) and to display a television image on the display of the portable terminal device to allow a user to view the television image.

FIG. 6 shows an overall structure of a portable phone capable of displaying a television image. The portable phone 1 comprises a portable phone unit 5, a television antenna 10, a tuner module 12 for receiving a TV (television) image signal, an RGB decoder 14 for separating and obtaining an R signal, a G signal, and a B signal from the TV image signal received at the tuner module 12, an LSI processor chip 16 for converting the R, G, and B signals into digital signals, applying various processes to the digital signals, and storing the digital signals in a memory, a liquid crystal panel (LCD panel) 20 which functions as a display, and an LCD controller (LCD driver) 18 for supplying the TV image signal to the LCD panel 20. The LCD panel 20 may have a resolution of, for example, QVGA (240×320 pixels) or VGA (480×640 pixels). The LSI processor chip 16 has two RAMs which function as field memories for storing each field data forming the TV image signal data. The TV image signal data stored in the RAM of the LSI processor chip 16 and then read from the RAM is temporarily stored in a RAM in the LCD controller 18 and then is supplied to the LCD panel 20. Therefore, as the RAM for storing the TV image signal data, there exist two RAMs within the LSI processor chip 16 and one RAM in the LCD controller 18.

FIG. 7 schematically shows a structure of a memory in the LSI processor chip 16 and in the LCD controller 18 of FIG. 6. The LSI processor chip 16 has two RAMs 16a and 16b and the LCD controller 18 has one RAM 18a. For the purpose of this description, the RAM 16a is referred to as a “first RAM”, the RAM 16b is referred to as a “second RAM”, and the RAM 18a is referred to as a “third RAM”.

After the TV image signal from the RGB decoder 14 is converted into a digital signal, the digital signal is alternately written into the first RAM 16a and to the second RAM 16b. The LCD controller 18 reads data from the RAM, among the two RAMs 16a and 16b, which is not at the timing of the writing of data, writes the read data to the third RAM 18a, and displays on the LCD panel 20. More specifically, while data is being written to the RAM 16a, the LCD controller 18 reads the data already written into the RAM 16b and writes the read data into the third RAM 18a.

Operations of each RAM will now be described in more detail referring to the timing chart shown in FIG. 8.

“Vsync” in FIG. 8 shows a signal waveform of a vertical synchronization signal Vsync of the TV image signal detected by asynchronization detector. Asis known, one television screen image is comprised of odd fields (ODD) and even fields (EVEN). In FIG. 8, a first odd field (ODD1) and a first even field (EVEN1) forming a first frame; a second odd field (ODD2) and a second even field (EVEN2) forming a second frame; and a third off field (ODD3) which is a part of a third frame, are shown.

The “First RAM” and “second RAM” shown in FIG. 8 respectively indicated the timings of write and read of the first RAM 16a and the second RAM16b. Similarly, “third RAM” in FIG. 8 shows the writing timing of the third RAM 18a. During the period of ODD1, field data of ODD1 is written into the first RAM 16a (in FIG. 8, “writeOl”) and field data of EVEN0 which is already written into the second RAM 16b during an EVEN0 period which is a field period before the ODD1 period is read from the second RAM 16b (in FIG. 8, “readE0”). In the timing chart, the “0” in “writeOl” indicates that the frame is the odd frame and “1” indicates that the field is the first field. In the field period of EVEN1 following ODD1, field date of ODD1 is read from the first RAM 16a and the field data of EVEN1 is written into the second RAM 16b. The field data of ODD1 read from the first RAM 16a is written into the third RAM 18a.

In the field period of ODD2 following EVEN1, field data of ODD2 is written into the first RAM 16a and field data of EVEN1 is read from the second RAM 16b and is written into the third RAM 18a. In the field period of EVEN2 following ODD2, field data of EVEN2 is written into the second RAM 16b, and the field data of ODD2 is read from the first RAM 16a and is written into the third RAM 18a.

In this manner, in each field period, the writing and reading operations to and from the first RAM 16a and the second RAM 16b are alternately performed, and each of field data of ODD and EVEN is sequentially written into the third RAM 18a and supplied to the LCD panel 20. Therefore, as shown in “LCD” in FIG. 8, TV screens are sequentially displayed on the LCD panel 20 in the order of first frame, second frame, etc., with a delay of one field period.

Japanese Patent Laid-Open Publication No. 2003-111004 discloses a portable phone which allows reception of the TV image signal and view of the TV image.

As described, it is possible to process a TV image signal by providing two RAMs on the LSI processor chip 16. However, the area occupied by the two RAMs in the LSI processor chip 16 is typically about 80%, and therefore, is a burden for further reduction of the size of the LSI processor chip 16, and, consequently, of the size of the portable terminal. Therefore, reduction of the number of memories is desired.

### SUMMARY OF THE INVENTION

When, for example, a resolution such as QVGA is used as the resolution of the LCD panel 20, because the vertical resolution is approximately 240, the LCD panel 20 does not have a resolution sufficient for displaying one frame of the TV image signal and it is sufficient to display data of one field. Even with such a configuration, the viewer would not notice a deficiency such as a flicker. Therefore, it is not necessary to process and store, in the LSI processor chip 16, all of two fields forming one frame.

The present invention advantageously provides a device in which the number of memories for storing TV image signal data is reduced and further reduction in size and cost of the device can be achieved.

According to one aspect of the present invention, there is provided an image signal processor circuit comprising an input unit for inputting a vertical synchronization signal for a television image signal; a storage unit for storing data of an odd field in the television image signal; and a controller unit for controlling a writing operation and a reading operation of data to and from the storage unit, wherein the controller unit writes data of the odd field to the storage unit during an odd field period defined by the vertical synchronization signal and reads the data of the odd field from the storage unit and outputs to the display during an even field period immediately before or after the odd field period.

According to another aspect of the present invention, it is preferable that, in the image signal processor circuit, the television image signal comprises a first frame and a second frame following the first frame; the first frame comprises a first odd field and a first even field; the second frame comprises a second odd field and a second even field; and the controller unit writes data of the first odd field to the storage unit during the first odd field period, reads the data of the first odd field from the storage unit and outputs to the display during the first even field period, writes data of the second odd field to the storage unit during the second odd field period, and reads the data of the second odd field from the storage unit and outputs to the display during the second even field period.

According to another aspect of the present invention, there is provided an image signal processor circuit comprising an input unit for inputting a vertical synchronization signal for a television image signal; a storage unit for storing data of an even field in the television image signal; a controller unit for controlling a writing operation and a reading operation of data to and from the storage unit, wherein the controller unit writes data of an even field to the storage unit during an even field period defined by the vertical synchronization signal and reads the data of the even field from the storage unit and outputs to the display during an odd field period immediately before or after the even field period.

According to another aspect of the present invention, it is preferable that, in the image signal processor circuit, the television image signal comprises a first frame and a second frame following the first frame; the first frame comprises a first odd field and a first even field; the second frame comprises a second odd field and a second even field; and the controller unit writes data of the first even field to the storage unit during the first even field period, reads the data of the first even field from the storage unit and outputs to the display during the second odd field period, writes data of the second even field to the storage unit during the second even field period, and reads the data of the second even field from the storage unit and outputs to the display during a field period subsequent to the second even field period.

According to another aspect of the present invention, it is preferable that the image signal processor circuit can be incorporated in a portable terminal device having a display for displaying the field data output from the image signal processor circuit.

The present invention may be more clearly understood by referring to the preferred embodiment described below. The scope of the present invention, however, is not limited to this preferred embodiment.

### BRIEF DESCRIPTION OF THE DRAWINGS

FIG. 1 is a diagram showing a structure of a RAM according to a preferred embodiment of the present invention.

FIG. 2 is a timing chart for a preferred embodiment of the present invention.

FIG. 3 is a timing chart for each unit in a preferred embodiment of the present invention.

FIG. 4 is another timing chart of a preferred embodiment of the present invention.

FIG. 5 is yet another timing chart of a preferred embodiment of the present invention.

FIG. 6 is a diagram showing an overall structure of a portable phone having a television image display function.

FIG. 7 is a diagram showing a structure of a RAM in a related art.

FIG. 8 is a timing chart of each unit in a related art.

### DESCRIPTION OF PREFERRED EMBODIMENT

A preferred embodiment of the present invention will now be described referring to the drawings and exemplifying a portable phone.

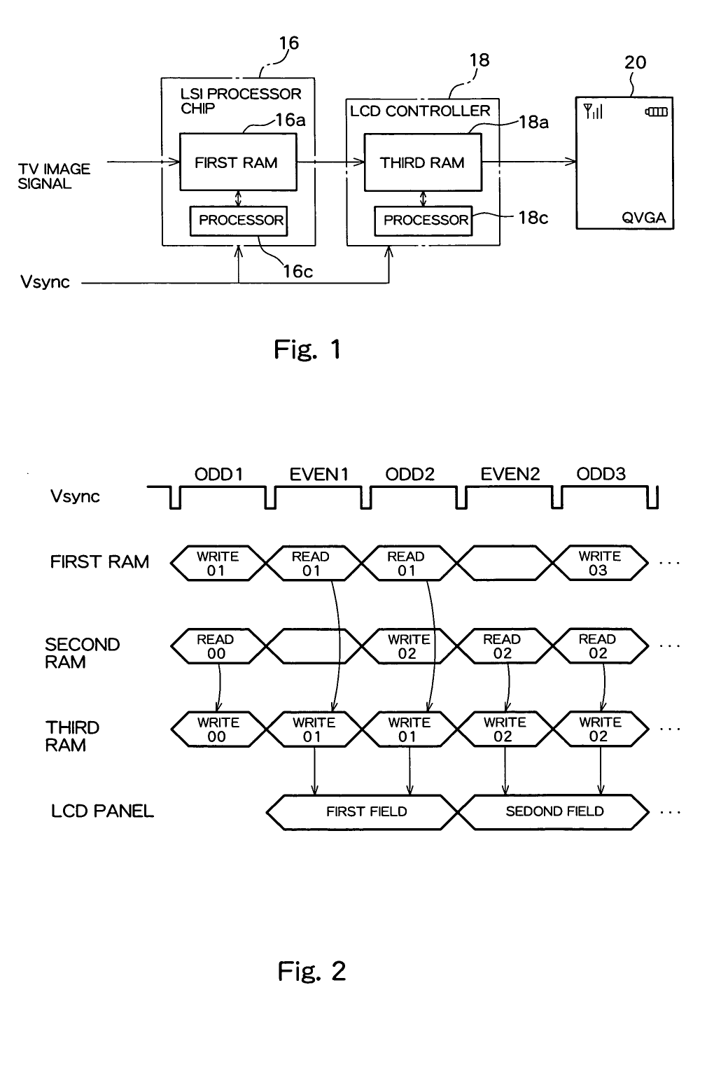

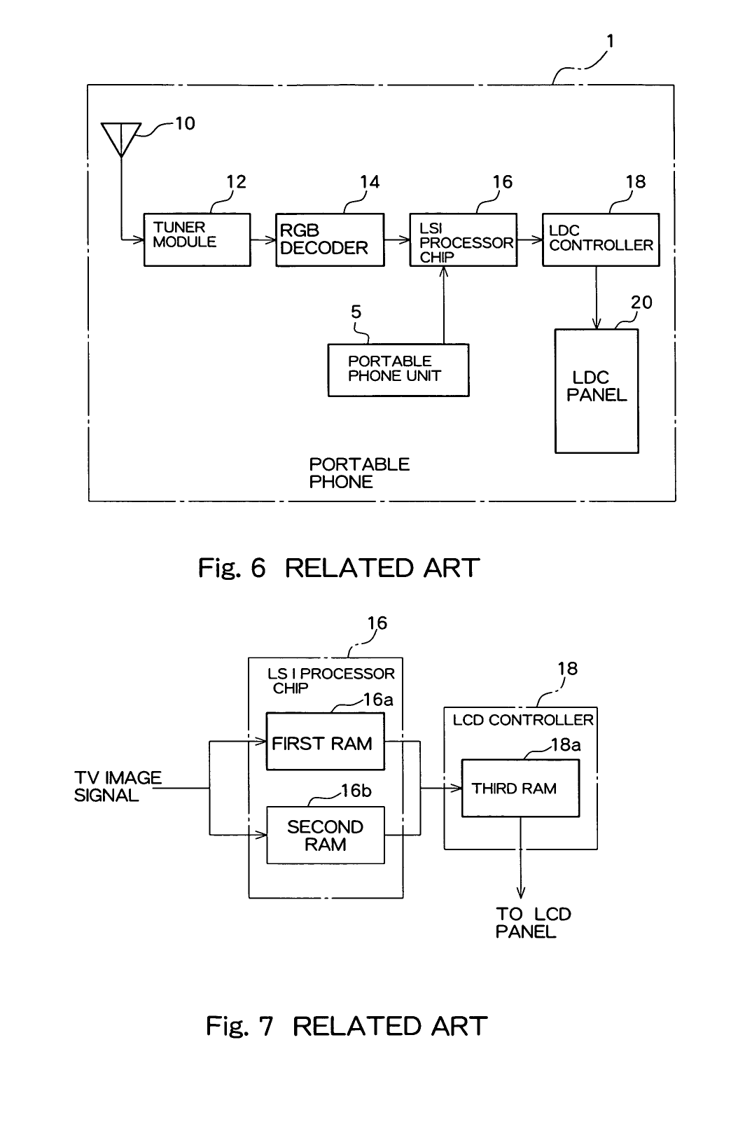

FIG. 1 shows essential components of a portable phone 1 which can display a TV image. The overall structure of the portable phone 1 is similar to that of the portable phone shown in FIG. 6, and therefore will not be described again.

Unlike the structure of FIG. 6 in which an LSI processor chip 16 has two RAMs (field memories) including a first RAM 16a and a second RAM 16b, in the present embodiment, the LSI processor chip 16 only has the first RAM 16a, and does not have a second RAM 16b. A write operation and a read operation of TV image signal data to and from the first RAM 16a are controlled by a processor 16c based on a vertical synchronization signal Vsync input to the LSI processor chip 16, and the processor 16c controls the write operation and read operation of the TV image signal data in a timing synchronized with Vsync through a bus. The first RAM 16a has a memory capacity of, for example, 1MB. By removing the second RAM 16b, it is possible to reduce the area on the LSI processor chip 16 occupied by the RAM by 50% or more, which therefore allows for reduction in the size of the LSI processor chip 16, and, consequently, the size of the portable phone 1.

An LCD controller 18 has a third RAM 18a. A write operation and a read operation of TV image signal data to and from the third RAM 18a are controlled by a processor 18c, and the processor 18c controls the write and read operations of TV image signal data in synchronization with Vsync to display the read TV image signal data on the LCD panel 20. The LCD panel 20 has a resolution of, for example, QVGA (240 in vertical direction×320 in horizontal direction) and displays a TV screen in a lateral direction.

In the present embodiment, the LSI processor chip 16 comprises only the first RAM 16a, and only one of an odd field (ODD) or an even field (EVEN) forming the TV screen is written to the first RAM 16a. When only the ODD field is written, the written ODD field is read from the first RAM 16a, written to the third RAM 18a, and is displayed on the LCD panel 20. Therefore, in this configuration, only the ODD field is displayed on the LCD panel 20. However, because the LCD panel 20 is small and has a low resolution, a viewer will not notice deficiencies. The vertical resolution of QVGA is approximately 240, which is approximately equal to the number of vertical scan signals forming the ODD field or the EVEN field which is 260 and, thus, this configuration is convenient for forming an image only with a field.

Before writing and reading operations to and from the first RAM 16a and the third RAM 18a in the present embodiment will be described, a processing of a TV image display using only ODD fields or EVEN fields which is a prerequisite for the present embodiment will first be described. This process can be executed by a structure shown in FIG. 7, that is, with the LSI processor chip 16 having two RAMs including the first RAM 16a and the second RAM 16b. Therefore, this process will be described referring to a system with the first RAM 16a and the second RAM 16b.

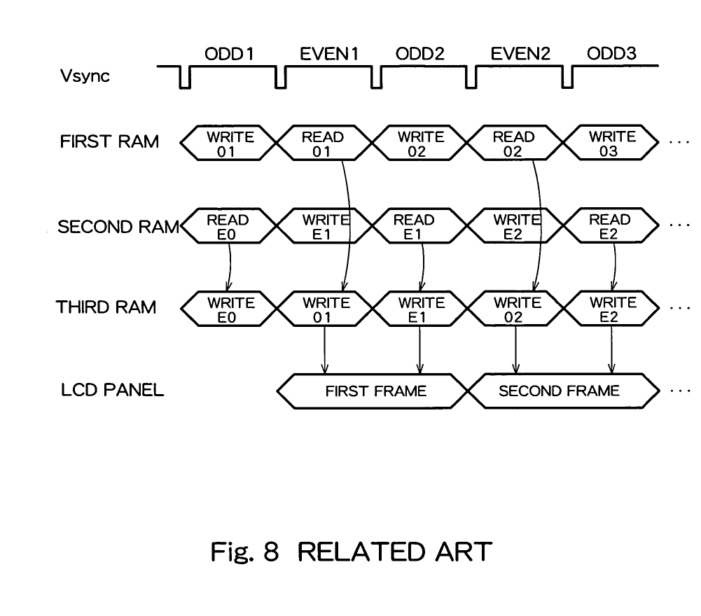

FIG. 2 shows a timing chart showing a vertical synchronization signal Vsync, first RAM 16a, second RAM 16b, third RAM 18, and LCD panel 20. FIG. 2 corresponds to FIG. 8.

During a field period of ODD1, field data of ODD1 is written to the first RAM 16a and field data of ODD0 which has been written to the second RAM 16b during the previous frame period is read from the second RAM 16b and is written to the third RAM 18a.

During a field period of EVENl following ODDl, no data is written to the RAMs and field data of ODD1 which is already written to the first RAM 16a is read from the first RAM 16a and is written to the third RAM 18a. The second RAM 16b, on the other hand, is not accessed and, thus, no writing or reading operation is performed.

During a field period of ODD2 following EVEN1, field data of ODD2 is written to the second RAM 16b. Reading of field data of ODD1 from the first RAM 16a and writing of data to the third RAM 18a continues. Here, it should be noted that reading of the field data of ODD1 written to the first RAM 16a during the field period of ODD1 continues during the EVEN1 and ODD2 field periods.

During a field period of EVEN2 following ODD2, field data of ODD2 is read from the second RAM 16b and is written to the third RAM 18a. The first RAM 16a, on the other hand, is not accessed, and no writing or reading operation is performed.

During a field period of ODD3 following EVEN2, field data of ODD3 is written to the first RAM 16a. The field data of ODD2 is continued to be read from the second RAM 16b and is written to the third RAM 18a.

In this manner, the ODD field data is alternately written to the first RAM 16a and to the second RAM 16b during only the ODD field periods. During the EVEN field period, on the other hand, data is not written, field data is read from the first RAM 16a or from the second RAM 16b, and ODD field data is sequentially written into the third RAM 18a and can be output to the LCD panel 20. Thus, on the LCD panel 20, a first field (an odd field which is a part of a first frame) and a second field (an odd field which is a part of a second frame) are sequentially displayed with a delay of one field period.

Referring to FIG. 2, during the field period of EVEN1, no data is written to or read from the second RAM 16b, and, therefore, the second RAM 16b is not useful. During the field period of ODD2, on the other hand, because the field data of ODD2 must be written, the field data of ODD2 is written to the second RAM 16b and field data of ODD1 is continued to be read from the first RAM 16a. However, the field data of ODD1 to be read during the field period of ODD2 is already read from the first RAM 16a and written to the third RAM 18a during the field period of EVEN1. In other words, it is possible to realize a display on the LCD panel 20 by continuing to read the field data already written to the third RAM 18a without again reading the field data from the first RAM 16a during the field period of ODD2. In this configuration, it is no longer necessary to read the field data of ODD1 from the first RAM 16a during the field period of ODD2 and the field data of ODD2 can be written to the first RAM 16a. This means that the access to the second RAM 16b during the field period of ODD2 also becomes unnecessary.

In the memory structure of the embodiment shown in FIG. 1, the second RAM 16b is removed from the LSI processor chip 16 according to the concept described above.

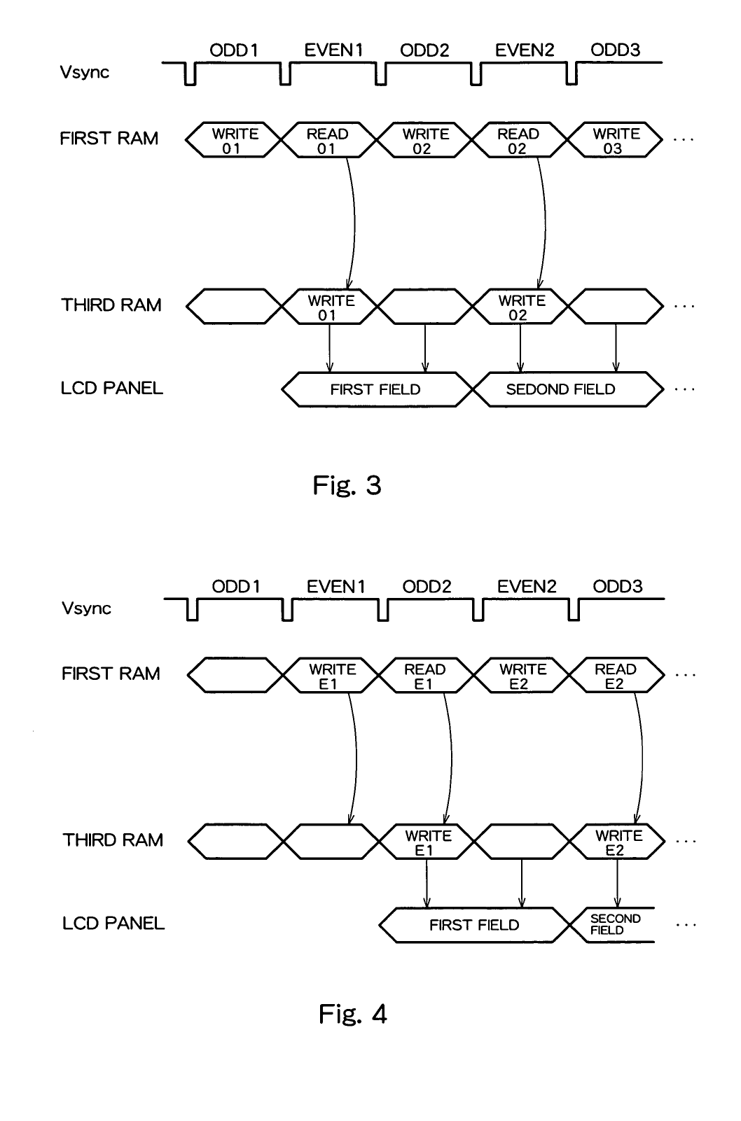

Processes in the memory structure of FIG. 1 will now be described referring to a timing chart of FIG. 3.

FIG. 3 shows a timing chart of a vertical synchronization signal Vsync, first RAM 16a, third RAM 18a, and LCD panel 20. During the field period of ODD1, the processor 16c writes, to the first RAM 16a, field data of ODD1 converted by an A/D converter on the LSI processor chip 16 into a digital signal.

During a field period of EVEN1 following ODD1, the processor 16c reads field data of ODD1 stored in the first RAM 16a and outputs the field data to the LCD controller 18. The processor 18c of the LCD controller 18 writes field data of ODD1 from the first RAM 16a to the third RAM 18a and displays the field data on the LCD panel 20. A field of ODD1 (first field) is displayed on the LCD panel 20.

During a field period of ODD2 following EVEN1, the processor 16c writes the field data of ODD2 from the A/D converter to the first RAM 16a. In synchronization with this timing, the processor 18c of the LCD controller 18 again reads the field data of ODD1 which is already stored in the third RAM 18a and displays on the LCD panel 20. Therefore, also in the field period of ODD2, display of the field of ODD1 on the LCD panel 20 continues.

During a field period of EVEN2 following ODD2, the processor 16c reads field data of ODD2 stored in the first RAM 16a and outputs to the LCD controller 18. The processor 18c of the LCD controller 18 writes field data of ODD2 from the first RAM 16a to the third RAM 18a and displays on the LCD panel 20. A field of ODD2 (second field) is displayed on the LCD panel 20.

During a field period of ODD3 following EVEN2, the processor 16c writes field data of ODD3 from the A/D converter to the first RAM 16a. At the same time, the processor 18c of the LCD controller 18 again reads the field data of ODD2 which is already stored in the third RAM 18a and displays on the LCD panel 20. Therefore, during the field period of ODD3 also, the field of ODD2 is continued to be displayed on the LCD panel 20.

In this manner, by providing only a first RAM 16a on the LSI processor chip 16, writing ODD field data to the first RAM 16a during an ODD field period, reading the ODD field data stored in the first RAM16a and writing the ODD field data to a third RAM 18a during an EVEN field period, and again reading the ODD field data stored in the third RAM 18a during the ODD field period, it is possible to display a TV image on the LCD panel 20 with a field frequency of 60 Hz.

Unlike typical TV imaging devices, a region of the LCD panel 20 on which a TV image is to be displayed is an image of 240×320 pixels elongated in the vertical direction. Therefore, in order to display the TV image in a lateral direction, it is possible to display a lateral screen by scanning in a vertical direction to read the field data sequentially stored in the lateral direction and supplying the read data to the LCD panel 20 while the field data stored in the first RAM 16a is being read from the first RAM 16a and written to the third RAM 18a.

In the timing chart of FIG. 2, ODD field data is written to the first RAM 16a during ODD field periods and only the odd field is displayed on the LCD panel 20. The present invention, however, is not limited to such a configuration, and it is possible, for example, to employ a configuration in which EVEN field data is written to the first RAM 16a during EVEN field periods and only the EVEN field is displayed on the LCD panel 20.

FIG. 4 shows a timing chart for a configuration in which only the EVEN field is displayed. During a field period of EVEN1 following ODD1, the processor 16c writes field data of EVEN1 to the first RAM 16a.

During a field period of ODD2 following EVEN1, the processor 16c reads field data of EVEN1 stored in the first RAM 16a and outputs to the LCD controller 18. The processor 18c of the LCD controller 18 writes field data of EVEN1 from the first RAM16a to the third RAM 18a and displays on the LCD panel 20. The field of EVEN1 is displayed on the LCD panel 20.

During a field period of EVEN2 following ODD2, the processor 16c writes field data of EVEN2 to the first RAM 16a. At the same time, the processor 18c of the LCD controller 18 again reads the field data of EVEN1 already stored in the third RAM 18a and displays on the LCD panel 20. Therefore, the EVEN1 field is continued to be displayed on the LCD panel 20.

As is clear from the timing chart of FIG. 3 or 4, in the embodiment, instead of outputting field data from the LSI processor chip 16 to the LCD controller 18 for each field period, the field data is output every other period. In other words, an image signal is transmitted from the LSI processor chip 16 to the LCD controller 18 in a rate of one image signal per each frame, and thus, the number of transmitted signal can also be reduced.

A preferred embodiment of the present invention has been described. The present invention, however, is not limited to this embodiment, and various modifications may be made.

For example, in the embodiment, ODD field data is written to the first RAM16a during every ODD field, but it is also possible to write the ODD field data to the first RAM 16a every other ODD field or every three ODD fields. For a signal of a fast moving TV image, the smoothness of movement of the TV image displayed on the LCD panel 20 would be lost, but for a signal of a TV image signal having relatively slower movement, no significant problem occurs.

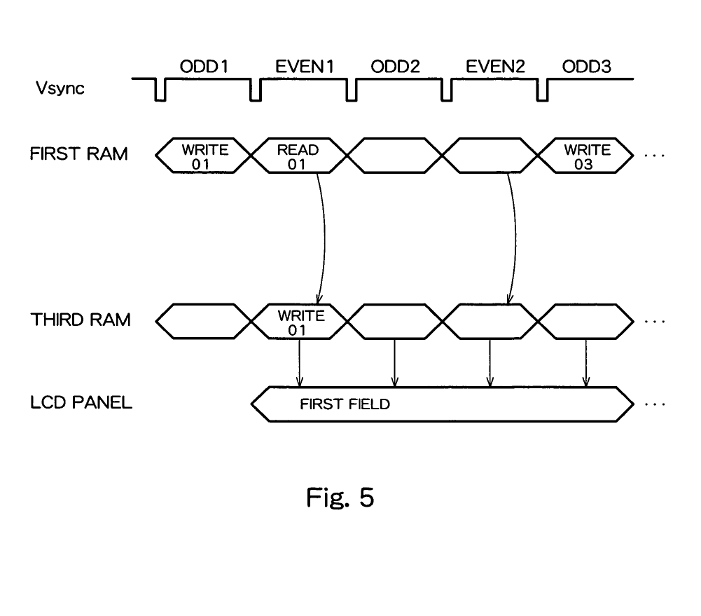

FIG. 5 shows a timing chart in which the ODD field data is written to the first RAM 16a every other ODD field. In a field period of ODD1, the processor 16c writes field data of ODD1 from the A/D converter to the first RAM 16a.

During a field period of EVEN1 following ODD1, the processor 16c reads the field data of ODD1 stored in the first RAM 16a and outputs to the LCD controller 18. The processor 18c of the LCD controller 18 writes the field data of ODD1 from the first RAM 16a to the third RAM 18a and displays on the LCD panel 20. The ODD1 field (first field) is displayed on the LCD panel 20.

During field periods of ODD2 and EVEN2 following EVEN1, the processor 16c does not access the first RAM 16a and does not read or write. The processor 18c of the LCD controller 18, on the other hand, repeatedly reads the field data of ODD1 already stored in the third RAM 18a and displays on the LCD panel 20.

During a field period of ODD3 following EVEN2, the processor 16c writes field data of ODD3 to the first RAM 16a. The processor 18c continues to read the field data of ODD1 stored in the third RAM 18a and displays on the LCD panel 20.

Although not shown in the figures, during a field period of EVEN3 following ODD3, the processor 16c reads the field data of ODD3 stored in the first RAM 16a and outputs to the LCD controller 18. The processor 18c writes the field data of ODD3 to the third RAM 18a and displays on the LCD panel 20. In this manner, field data is written to the first RAM 16a in each field of ODD1, ODD3, ODD5, . . . and displayed on the LCD panel 20.

A similar configuration maybe employed in a structure in which only the EVEN field is written to the first RAM 16a and displayed on the LCD panel 20. In this configuration, data is written only during the fields of EVEN1, EVEN3, EVEN5, . . . and displayed on the LCD panel 20.

It is also possible to determine in the processor 16c and/or in the processor 18c whether or not to “skip” as described above or to adjust an amount of skipping, based on an amount of movement of a TV image data by supplying a signal indicating the amount of movement of TV image (such as a movement vector) to the processor 16c and/or processor 18c. For example, when the amount of movement is large, the data may be written during every ODD field or during every EVEN field as shown in FIG. 2 or 3, and, when the amount of movement is small, the data may be written every other ODD or EVEN field or every three ODD or EVEN fields. It is also possible to identify code or other data indicating program contents of the TV image signal, and to set whether or not to apply skipping individually for each program. It is clear to a person with ordinary skill in the art that the amount of movement of TV image varies among programs. It is also possible to provide, on the portable phone 1, a switch or a button to allow a user to select whether or not a “skipping” operation should be applied.

In the examples described above, the present invention has been described exemplified by implementation in a potable phone. The present invention, however, is not limited to portable phones, and may be applied to any device having a function to display a TV image, such as, for example, a PDA (personal digital assistant) or the like.

In the embodiments, the LSI processor chip 16 is described as having one RAM 16a as shown in FIG. 1. This description, however, merely indicates that a single RAM (field memory) for storing field data of the TV image signal is provided instead of a plurality of RAMs for storing field data, and other RAMs or the like may be provided on the LSI processor chip 16 for storing data other than the field data.

1. An image signal processor circuit for processing a television image signal and displaying an image on a display, the image signal processor circuit comprising:
an input unit for inputting a vertical synchronization signal for the television image signal;
a storage unit for storing data of an odd field in the television image signal; and
a controller unit for controlling a writing operation and a reading operation of data to and from the storage unit, wherein the controller unit writes data of an odd field to the storage unit during an odd field period defined by the vertical synchronization signal and reads the data of the odd field from the storage unit and outputs to the display during an even field period immediately before or after the odd field period.

2. An image signal processor circuit according to claim 1, wherein
the television image signal comprises a first frame and a second frame following the first frame;
the first frame comprises a first odd field and a first even field;
the second frame comprises a second odd field and a second even field; and
the controller unit writes data of the first odd field to the storage unit during the first odd field period, reads the data of the first odd field from the storage unit and outputs to the display during the first even field period, writes data of the second odd field to the storage unit during the second odd field period, and reads the data of the second odd field from the storage unit and outputs to the display during the second even field period.

3. An image signal processor circuit according to claim 1, wherein
the television image signal comprises a first frame and an nth frame after the first frame (n is a natural number greater than 2);
the first frame comprises a first odd field and a first even field;
the nth frame comprises an nth odd field and an nth even field; and
the controller unit writes data of the first odd field to the storage unit during the first odd field period, reads the data of the first odd field from the storage unit and outputs to the display during the first even field period, reads the data of the first odd field from the storage unit and outputs to the display during each field period from a second frame to (n−1)th frame, writes data of the nth odd field to the storage unit during the nth odd field period, and reads the data of the nth odd field from the storage unit and outputs to the display during the nth even field period.

4. An image signal processor circuit for processing a television image signal and displaying and image on a display, the image signal processor circuit comprising:
an input unit for inputting a vertical synchronization signal for the television image signal;
a storage unit for storing data of an even field in the television image signal; and
a controller unit for controlling a writing operation and a reading operation of data to and from the storage unit, wherein the controller unit writes data of an even field to the storage unit during an even field period defined by the vertical synchronization signal and reads the data of the even field from the storage unit and outputs to the display during an odd field period immediately before or after the even field period.

5. An image signal processor circuit according to claim 4, wherein
the television image signal comprises a first frame and a second frame after the first frame;
the first frame comprises a first odd field and a first even field;
the second frame comprises a second odd field and a second even field; and
the controller unit writes data of the first even field to the storage unit during the first even field period, reads the data of the first even field from the storage unit and outputs to the display during the second odd field period, writes data of the second even field to the storage unit during the second even field period, and reads the data of the second even field from the storage unit and outputs to the display during a field period subsequent to the second even field period.

6. An image signal processor circuit according to claim 4, wherein
the television image signal comprises a first frame and an nth frame following the first frame (n>2);
the first frame comprises a first odd field and a first even field;
the nth frame comprises an nth odd field and an nth even field;
and
the controller unit writes data of the first even field to the storage unit during the first even field period, reads the data of the first even field from the storage unit and outputs to the display during each field period from a second frame to the nth odd field of the nth frame, writes data of the nth even field to the storage unit during the nth even field period, and reads the data of the nth even field from the storage unit and outputs to the display during a field period subsequent to the nth even field period.

7. An image signal processor circuit according to claim 1, further comprising:
a display storage unit for temporarily storing field data read from the storage unit and output and for outputting to the display.

8. An image signal processor circuit according to claim 4, further comprising:
a display storage unit for temporarily storing field data read from the storage unit and output and for outputting to the display.

9. An image signal processor circuit for processing a television image signal and displaying an image on a display, the image signal processor circuit comprising:
a first memory for storing data of an odd field in the television image signal;
a first processor for controlling a writing operation and a reading operation of data to and from the first memory, wherein the first processor writes data of an odd field to the first memory during an odd field period defined by a vertical synchronization signal for the television image signal and reads the data of odd field from the first memory and outputs during an even field period following the odd field period;
a second memory for storing data of an odd field read from the first memory and output during the even field period; and
a second processor for controlling a writing operation and a reading operation of data to and from the second memory, wherein the second processor writes the data of the odd field to the second memory during the even field period and reads the data of odd field written to the second memory during the even field and outputs to the display during a second odd field period following the even field period.

10. An image signal processor circuit for processing a television image signal and displaying an image on a display, the image signal processor circuit comprising:
a first memory for storing data of an even field in the television image signal;
a first processor for controlling a writing operation and a reading operation of data to and from the first memory, wherein the first processor writes data of an even field to the first memory during an even field period defined by a vertical synchronization signal for the television image signal and reads the data of even field from the first memory and outputs during an odd field period following the even field period;
a second memory for storing data of an even field read from the first memory and output during the odd field period; and
a second processor for controlling a writing operation and a reading operation of data to and from the second memory, wherein the second processor writes the data of even field to the second memory during the odd field period and reads the data of even field written to the second memory during the odd field period and outputs to the display during a second even field period following the odd field period.

11. A portable terminal device comprising:
an image signal processor circuit; and
a display for displaying field data output from the image signal processor circuit, wherein
the image signal processor circuit comprises:
an input unit for inputting a vertical synchronization signal for a television image signal;
a storage unit for storing data of an odd field in the television image signal; and
a controller unit for controlling a writing operation and a reading operation of data to and from the storage unit, wherein the controller unit writes data of an odd field to the storage unit during an odd field period defined by the vertical synchronization signal and reads the data of the odd field from the storage unit and outputs to the display during an even field period immediately before or after the odd field period.

12. A portable terminal device according to claim 11, further comprising:
a display storage unit for temporarily storing field data read from the storage unit and output and for outputting to the display.

13. A portable terminal device comprising:
an image signal processor circuit; and
a display for displaying field data output from the image signal processor circuit, wherein
the image signal processor circuit comprises:
an input unit for inputting a vertical synchronization signal for a television image signal;
a storage unit for storing data of an even field in the television image signal, and
a controller unit for controlling a writing operation and a reading operation of data to and from the storage unit, wherein the controller unit writes data of an even field to the storage unit during an even field period defined by the vertical synchronization signal and reads the data of the even field from the storage unit and outputs to the display during an odd field period immediately before or after the even field period.

14. A portable terminal device according to claim 13, further comprising:
a display storage unit for temporarily storing field data read from the storage unit and output and for outputting to the display.

15. A portable terminal device comprising:
a first memory for storing data of an odd field in a television image signal;
a first processor for controlling a writing operation and a reading operation of data to and from the first memory, wherein the first processor writes data of an odd field to the first memory during an odd field period defined by a vertical synchronization signal for the television image signal and reads the data of odd field from the first memory and outputs during an even field period following the odd field period;
a second memory for storing data of an odd field read from the first memory and output during the even field period;
a second processor for controlling a writing operation and a reading operation of data to and from the second memory, wherein the second processor writes the data of odd field to the second memory during the even field and reads the data of odd field written to the second memory during the even field period and outputs during a second odd field period following the even field period, and
a display for sequentially displaying data of odd field output from the second processor, wherein data of even field is not displayed.

16. A portable terminal device comprising:
a first memory for storing data of an even field in a television image signal;
a first processor for controlling a writing operation and a reading operation of data to and from the first memory, wherein the first processor writes data of an even field to the first memory during an even field period defined by a vertical synchronization signal of the television image signal and reads the data of even field form the first memory and outputs during an odd field period following the even field period;
a second memory for storing data of an even field read from the first memory and output during the odd field period;
a second processor for controlling a writing operation and a reading operation of data to and from the second memory, wherein the second processor writes the data of even field to the second memory during the odd field period and reads the data of the even field written to the second memory during the odd field period and outputs during a second even field period following the odd field period, and
a display for sequentially displaying data of even field output from the second processor, wherein data of odd field is not displayed.
